(19) United States
(12) Patent Application Publication
(10) Pub. No.: US 2011/0149063 A1
(43) Pub. Date: Jun. 23, 2011

(54) MEASUREMENT DEVICE AND METHOD OF DOUBLE-SIDED OPTICAL FILMS

(75) Inventors: SHU-PING DONG, Taichung County (TW); HUNG-MING TAI, Hsinchu City (TW); DEH-MING SHYU, Miaoli County (TW); CHI-TANG CHEN, Nantou County (TW); CHING-MING YEH, Hsinchu City (TW); YI-CHANG CHEN, Miaoli County (TW); CHIA-CHI HUANG, Tainan City (TW)

(73) Assignee: Industrial Technology Research Institute, Hsinchu (TW)

(21) Appl. No.: 12/877,173

(22) Filed: Sep. 8, 2010

(30) Foreign Application Priority Data
Dec. 17, 2009 (TW) 098143293

(51) Int. Cl. H04N 5/253; G06K 9/00

(52) U.S. Cl. 348/96; 382/100; 348/E05.049

(57) ABSTRACT

The present invention provides a measurement device and a measurement method of double-sided optical films, wherein the device and the method make use of an illumination light source with well-designed bright fields and dark fields and a device with double-sided coincidence optics to obtain the variation information about the horizontal mismatch and the angular mismatch of double-sided optical films.

### TECHNICAL FIELD

The present disclosure relates to a measurement device and method of double-sided optical films, and more particularly, to an image measurement device and method for detecting horizontal error and angular error of a double-sided optical film.

### TECHNICAL BACKGROUND

In flat liquid crystal display panels, white light that made up of waves fluctuating at all possible angles and is projected into the flat panel is converted and polarized by absorption in to a plane-polarized light, which is a polarized light vibrating in a single plane perpendicular to the direction of propagation, by the use of a polarizer. However, it is going to cause a server intensity loss resulting from the polarization, i.e. about 60% of light will be lost. On the other hand, if pigment color filers are used in flat liquid crystal display panels for achieving a full-color image with intensities of all three primary colors represented at each pixel, there will be about 70% of light will be lost since the color filter filters the incident white light by wavelength range in a manner that it will absorb certain wavelengths of light, letting only a portion of the visible part of the electromagnetic spectrum pass through, and thus gives information about the intensity of light in red, green, and blue (RGB) wavelength regions. Accordingly, most of light in the liquid crystal displays (LCDs) is wasted so that the overall performance efficiency is only about 3% to 6%.

It is noted that there are already many nanostructure films being provided and used in LCDs for enhancing the performance of the same with respect to power consumption. One of which is a dye-less color filter 10 disclosed in FIG. 1, which is substantially a diffractive optical film designed for splitting light. The dye-less color filter 10 of FIG. 1 is primarily comprised of: a color separation film 11 and a double-sided optical film 12.

As shown in FIG. 1, the double-sided optical film 12 is composed of a plurality of parallel-arranged beam splitters 121, and each of the beam splitters 121 is comprised of: a first optical elements 1211 and a second optical elements 1212. In the embodiment shown in FIG. 2, the first optical element 1211 is a lenticular lens and the second optical element 1212 is a prism lens. Accordingly, the key factor affecting the performance of the double-sided optical film 12 will be the alignment between the two corresponding optical elements 1211, 1212 in the beam splitters 121, relating to the horizontal mismatch and angular mismatch.

During the manufacturing of the double-sided optical film 12 by a hot embossing process, or an UV embossing process, the horizontal mismatch and angular mismatch of the two corresponding optical elements 1211, 1212 in the beam splitters 121 will cause severe defects to the so-produced double-sided optical film 12, such as decentering and optical axis shift, as such defects will lead to light leakage and variations in beam deflection.

Although the use of embossing technique for producing double-sided optical films is advantageous in production cost and yield, the high demand relating to the precision of the resulting double-sided optical films usually can not be achieved. The most troublesome problem in the embossing process relates to the dealing with the horizontal mismatch and angular mismatch in the double-sided optical films since the two types of mismatches not only will cause the light emitted out from the double-sided optical films to be distributed unevenly, but also will cause the light splitting efficiency of the same to decrease in great proportion. Thus, it is important to have a means capable of measuring the foregoing structural mismatches accurately, by that the sources for causing such mismatches as well as the amount of mismatch can be identified and measured so as to be used as feedbacks to the film driving apparatus of the embossing process in a repetitive manner for calibrating the mismatches.

Please refer to FIG. 3, which is a three-dimensional view showing a process of for creating embossed lenticular film with parallel print alignment, disclosed in U.S. Pat. No. 6,989,931, entitled “Lenticular Optical System”. The film web 204 is first printed with parallel line indicia 205 and with registration marks 206. Optical (or other sensory devices) 207 read the parallel line pattern 205 and/or the registration marks 206 guide the print lines straight into the embosser with its edge guide 208 and embossing cylinder 209 with its annular parallel grooves 210, thereby producing parallel embossed lenticular ridges which are mutually parallel to the print line indicia.

### TECHNICAL SUMMARY

In an embodiment, the present disclosure provides a measurement method of double-sided optical films, which comprises the steps of: providing an double-sided optical film characterized by a first profile and a second profile; generating a first image of the first profile and a corresponding second image of the second profile in a simultaneous manner; enabling the first image and the second image to overlap with each other so as to form a superimposed image; capturing the superimposed image; and analyzing the superimposed image so as to obtain a value relating to the horizontal mismatch of the double-sided optical film.

In another embodiment, the present disclosure provides a measurement method of double-sided optical films, which comprises the steps of: providing an double-sided optical film characterized by a first profile and a second profile whereas the double-sided optical film is made up of a plurality of parallel-arranged beam splitters; capturing a first image and a second image relating to the first profile and simultaneously capturing a third image of the second profile corresponding to the first image of the first profile and also a fourth image of the second profile corresponding to the second image of the first profile while enabling the capturing processes of the first image and the second image are performed at different location spaced from each other by a specific distance; enabling the first image and the third image to overlap with each other so as to form a first superimposed image while enabling the second image and the fourth image to overlap with each other so as to form a second superimposed image; respectively capturing the first superimposed image and the second superimposed image; analyzing the first superimposed image so as to obtain a first horizontal mismatch value while analyzing the second superimposed image so as to obtain a second horizontal mismatch value; and basing upon the first horizontal mismatch value and the second horizontal mismatch value to calculate a angular mismatch value of the double-sided optical film.

Moreover, in an embodiment, the present disclosure provides a measurement device adapted for measuring a double-sided optical film characterized by a first profile and a corresponding second profile, which comprises: a first image capturing unit, for generating a first image relating to the first profile; a second image capturing unit, disposed at a position corresponding to the first image capturing unit for generating a second image of the second profile; a superimposition unit, for enabling the first image and the second image to overlap with each other so as to form a superimposed image; and an imaging unit, for capturing the superimposed image.

In yet another embodiment, the present disclosure provides a measurement device adapted for measuring a double-sided optical film characterized by a first profile and a corresponding second profile, which comprises: a plurality of horizontal mismatch measurement units, being disposed spaced from one another by a specific distance so as to obtain various horizontal mismatch values of the double-sided optical film in correspondence to their different positions, each horizontal mismatch measurement unit further comprising: a first image capturing unit, for generating a first image relating to the first profile; a second image capturing unit, disposed at a position corresponding to the first image capturing unit for generating a second image of the second profile; a superimposition unit, for enabling the first image and the second image to overlap with each other so as to form a superimposed image; and an imaging unit, for capturing the superimposed image.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a sectional view of a conventional dye-less color filter.

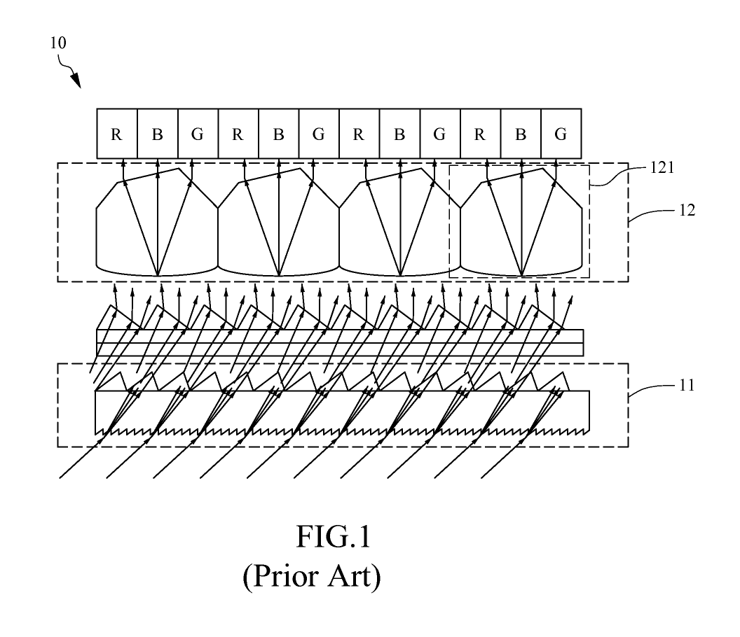

FIG. 2 is a sectional view of a conventional beam splitter used in the dye-less color filter of FIG. 1.

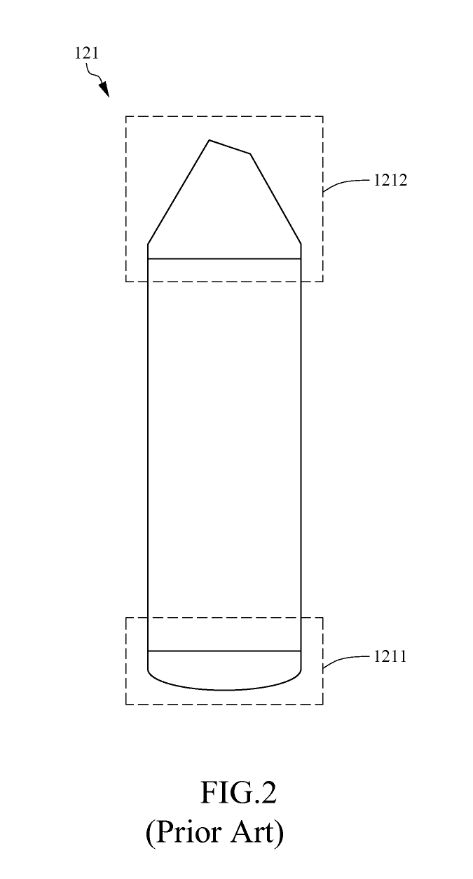

FIG. 3 is a three-dimensional view showing a process of for creating embossed lenticular film with parallel print alignment, disclosed in U.S. Pat. No. 6,989,931.

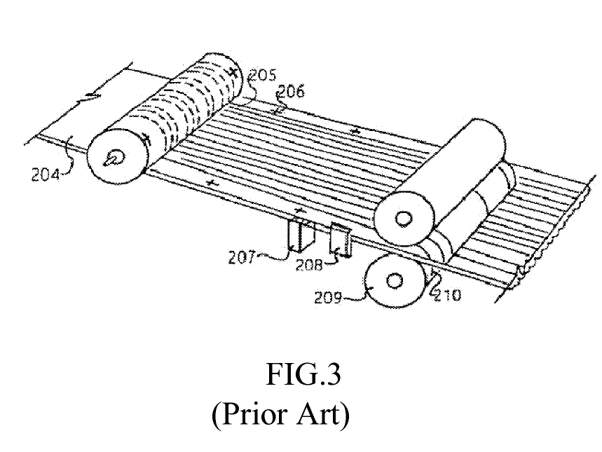

FIG. 4 is a flow chart depicting steps of a measurement method of double-sided optical films according to an embodiment of the present disclosure.

FIG. 5 is a flow chart depicting steps of a measurement method of double-sided optical films according to another embodiment of the present disclosure.

FIG. 6 is a schematic diagram showing a measurement device of double-sided optical films according to an embodiment of the present disclosure.

FIG. 7A to FIG. 7C show an image analysis for obtaining horizontal mismatch values in the present disclosure.

FIG. 8 is a schematic diagram showing a measurement device of double-sided optical films according to another embodiment of the present disclosure.

FIG. 9 is a schematic diagram showing a measurement device of double-sided optical films according to yet another embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

In the hot embossing process or UV embossing process, the machining platform is generally equipped with upper rollers and lower rollers that are all being formed with microstructure patterns on the surface thereof, and in some case, the microstructure pattern can be double-sided lenticular lens structure. Thus, it is common in the hot embossing process or UV embossing process that the so-produced double-sided optical films are going to suffer by the horizontal mismatch and angular mismatch problems which will lead to decentering and optical axis shift to the double-sided optical films, and thus lead to light leakage and variations in beam deflection. However, if it is intended to overcome the horizontal mismatch and angular mismatch problems by forming alignment marks on the rollers, a tool changing process must be performed on the machining platform and that will cause another kinds of error to the so-produced double-sided optical films. In view of the disadvantages of prior art, the device and method provided in the present disclosure use structures formed on the surface of double-sided optical films as the required alignment marks so that the alignment of the double-sided optical films can be inspected directly without requiring any tool changing process for forming additional alignment marks.

The measurement device and method of double-sided optical films provided in the present disclosure are adapted for inspecting and measuring the horizontal mismatch and angular mismatch of double-sided optical films as they are produced by hot embossing process or UV embossing. In addition, there is no additional means for forming alignment marks required in the measurement device of double-sided optical films provided in the present disclosure since the measurement device of the present disclosure is able to obtain the alignment displacement information depending solely on the structures on the inspected double-sided optical film itself. Moreover, the device and method of the present disclosure are able to use one charge-coupled device (CCD) to directly capture and display information relating to horizontal mismatch, and the same time, obtain information relating to angular mismatch in an non-contact manner without any tampering to the inspected double-sided optical film.

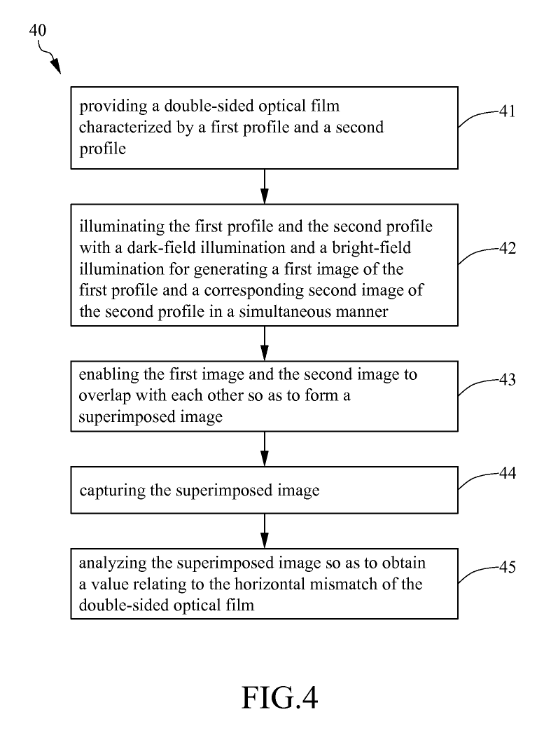

Please refer to FIG. 4, which is a flow chart depicting steps of a measurement method of double-sided optical films according to an embodiment of the present disclosure. The measurement method of double-sided optical films 40 comprises the steps of:
Step 41: providing a double-sided optical film characterized by a first profile and a second profile;
Step 42: illuminating the first profile and the second profile with a mixed illumination of a dark-field illumination and a bright-field illumination for generating a first image of the first profile and a corresponding second image of the second profile in a simultaneous manner;
Step 43: enabling the first image and the second image to overlap with each other so as to form a superimposed image;
Step 44: capturing the superimposed image; and
Step 45: analyzing the superimposed image so as to obtain a value relating to the horizontal mismatch of the double-sided optical film.

In step 42, as the double-sided optical films are transparent films that under ordinary illumination, the images obtained from the step 42 are almost not analyzable but only the edges thereof can barely be identified, it is required to use a dark-field illumination so as to enhance the edges in the so-obtained images and thus obtain edge information accordingly. Moreover, only by the use of the dark-field illumination, the air bubbles or hollows in the so-obtained image will also cause difficulties for obtaining any information from the image. Therefore, the first profile and the second profile is illuminated by a mixed illumination of a dark-field illumination and a bright-field illumination for facilitating the obtaining of surface profile information and information resulting from transmission light.

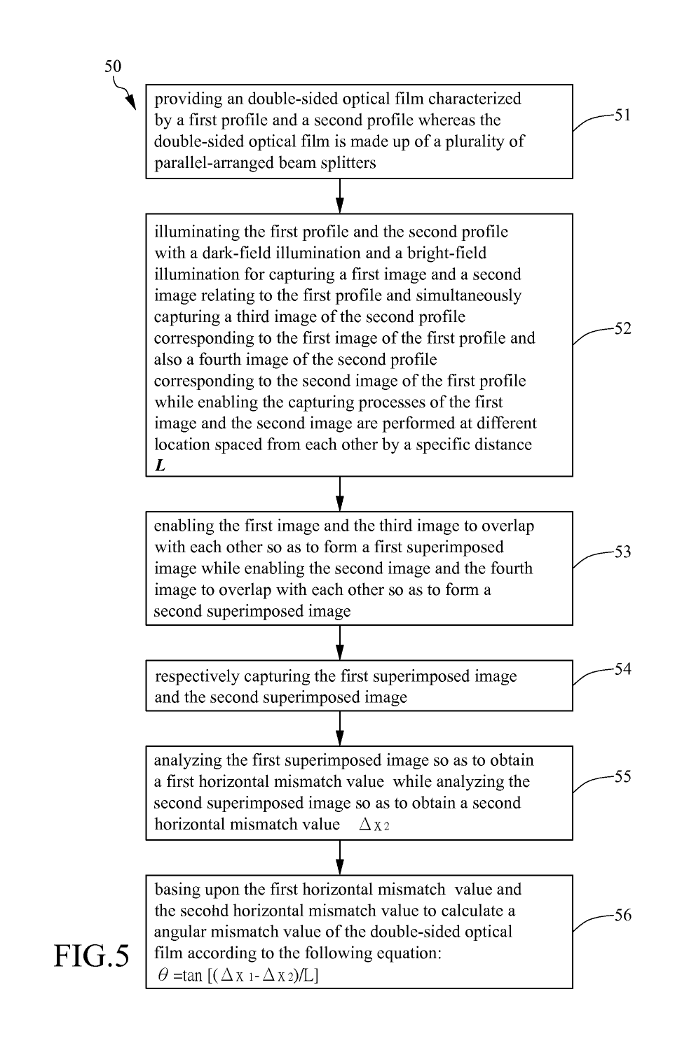

Please refer to FIG. 5, which is a flow chart depicting steps of a measurement method of double-sided optical films according to another embodiment of the present disclosure. The measurement method of double-sided optical films 50 comprises the steps of:
Step 51: providing an double-sided optical film characterized by a first profile and a second profile whereas the double-sided optical film is made up of a plurality of parallel-arranged beam splitters;
Step 52: illuminating the first profile and the second profile with a dark-field illumination and a bright-field illumination for capturing a first image and a second image relating to the first profile and simultaneously capturing a third image of the second profile corresponding to the first image of the first profile and also a fourth image of the second profile corresponding to the second image of the first profile while enabling the capturing processes of the first image and the second image are performed at different location spaced from each other by a specific distance L;
Step 53: enabling the first image and the third image to overlap with each other so as to form a first superimposed image while enabling the second image and the fourth image to overlap with each other so as to form a second superimposed image;
Step 54: respectively capturing the first superimposed image and the second superimposed image;
Step 55: analyzing the first superimposed image so as to obtain a first horizontal mismatch value Δx₁ while analyzing the second superimposed image so as to obtain a second horizontal mismatch value Δx₂; and
Step 56: basing upon the first horizontal mismatch value and the second horizontal mismatch value to calculate a angular mismatch value of the double-sided optical film according to the following equation:

θ=tan⁻¹[(Δx₁−Δx₂)/L].

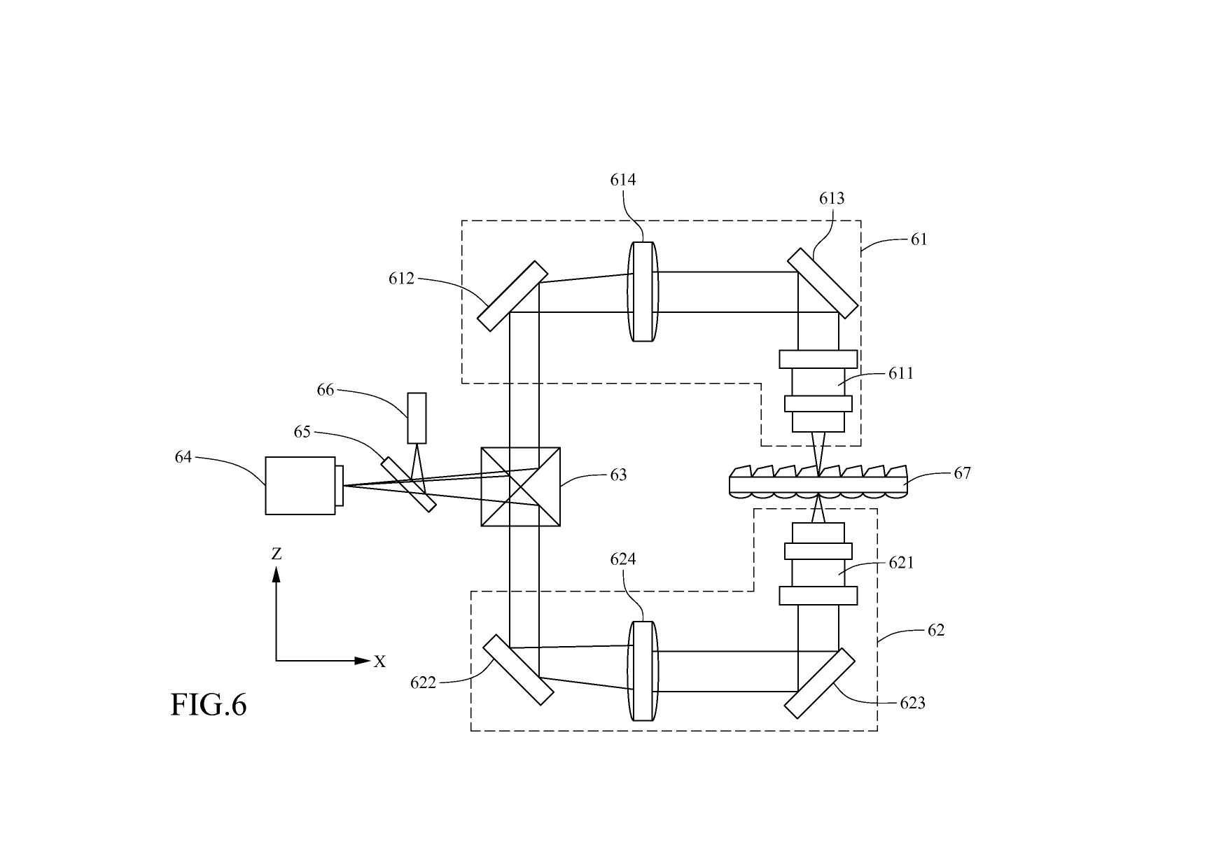

Moreover, the present disclosure also provides a measurement device adapted for the aforesaid measurement method of double-sided optical films. Please refer to FIG. 6, which is a schematic diagram showing a measurement device of double-sided optical films according to an embodiment of the present disclosure. As shown in FIG. 6, a measurement device 60 adapted for measuring a double-sided optical film 67 characterized by a first profile and a corresponding second profile is disclosed, which comprises:
a first image capturing unit 61, for generating a first image relating to the first profile;
a second image capturing unit 62, disposed at a position corresponding to the first image capturing unit 61 for generating a second image of the second profile;
a superimposition unit 63, for enabling the first image and the second image to overlap with each other so as to form a superimposed image; and an imaging unit 64, for capturing the superimposed image.

In an embodiment, the superimposition unit 63 can be a double-image prism, and the imaging unit 64 can be a CCD. In addition, there can be a semi reflector 65 being disposed at a position on the optical path between the double-image prism 63 and the imaging unit 64 while enabling the same to receive light from a light source 66 for allowing a portion of the light to be reflected toward the double-image prism 63.

Moreover, the first image capturing unit 61 is further comprised of:
a first objective lens 611;
a first reflector 612, disposed at a position on the optical path between the first objective lens 611 and the double-image prism 63 for reflecting light impinging thereon;
a second reflector 613, disposed at a position on the optical path between the first objective lens 611 and the first reflector 612 for reflecting light impinging thereon; and
an imaging lens 614, disposed at a position on the optical path between the first reflector 612 and the second reflector 613 for focusing and imaging.
   Similarly, the second image capturing unit 62 is further comprised of:

a second objective lens 621;
a first reflector 622, disposed at a position on the optical path between the second objective lens 621 and the double-image prism 63 for reflecting light impinging thereon;
a second reflector 623, disposed at a position on the optical path between the second objective lens 621 and the first reflector 622 for reflecting light impinging thereon; and
an imaging lens 624, disposed at a position on the optical path between the first reflector 622 and the second reflector 623 for focusing and imaging.

During the performing of a measurement, an double-sided optical film to be measured 67 is placed between the first objective lens 611 and the second objective lens 621 whereas the first objective lens 611 and the second objective lens 621 are disposed opposite to and mirroring to each other. While defining by a Cartesian coordinate system of X, Y and Z axes, as shown in FIG. 6, if the double-sided optical film 67 is placed on XY-plane, the first objective lens 611 and the second objective lens 621 will be disposed opposite to and mirroring to each other with respect to the XY-plane. In addition, the optical path from the double-sided optical film 97 to the imaging unit 64 through the first image capturing unit 61 and the superimposition unit 63 is located on the XZ-plane while the optical path from the double-sided optical film 97 to the imaging unit 64 through the second image capturing unit 62 and the superimposition unit 63 is also located on the XZ-plane.

By the use of the measurement device 60 disclosed in the aforesaid embodiment to apply the measurement method 40 of the present disclosure, a value relating to the horizontal mismatch in the double-sided optical film 67 can be measured.

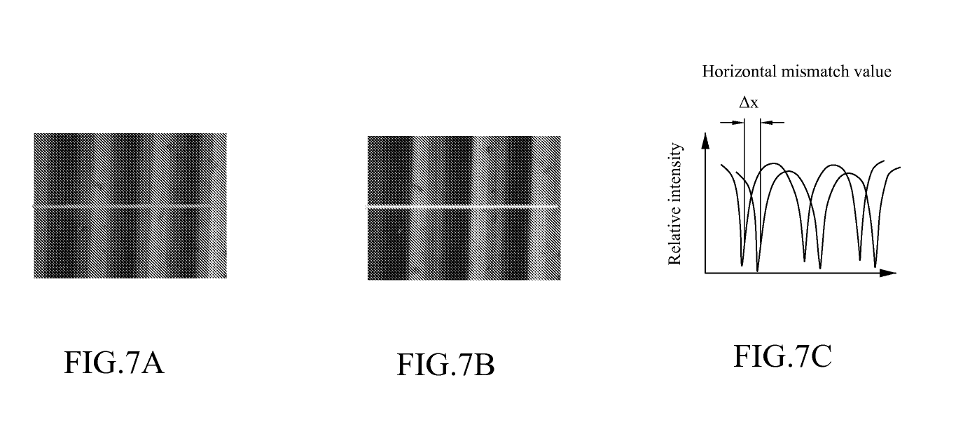

Please refer to FIG. 7A to FIG. 7C, which show an image analysis for obtaining horizontal mismatch values in the present disclosure, FIG. 7A shows a first image of the first profile in the double-sided optical film 67 that is captured by the first image capturing unit 61. FIG. 7B shows a second image of the second profile in the double-sided optical film 67 that is captured by the second image capturing unit 62. It is noted that the first image and the second image are images relating to the same area of the double-sided optical film 67 but are taken on different profiles of the same. FIG. 7C shows a analysis resulting from the superimposed image of the superimposition unit 63 that is taken by the imaging unit 64. As shown in FIG. 7C, the value relating to the horizontal mismatch Δx in the double-sided optical film 67 can be obtained form the information of relative intensity distribution.

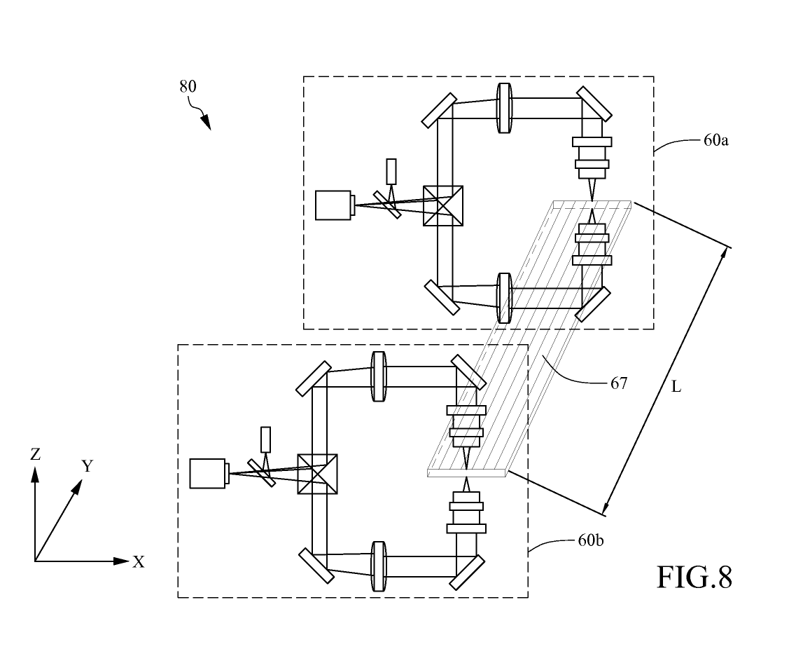

Please refer to FIG. 8, which is a schematic diagram showing a measurement device of double-sided optical films according to another embodiment of the present disclosure. As shown in FIG. 8, a measurement device 80 adapted for measuring a double-sided optical film 67 characterized by a first profile and a corresponding second profile is disclosed, which includes: two measurement units 60a, 60b, each for measuring horizontal mismatches relating to different locations on the double-sided optical film 67. It is noted that the two measurement units 60a, 60b are disposed spaced from each other by a specific distance L along a line parallel with the beam splitters, and each of the two measurement units 60a, 60b is configured the same as the measurement device 60 of FIG. 6 in view of function, structure and operation.

While defining by a Cartesian coordinate system of X, Y and Z axes, as shown in FIG. 8, if the double-sided optical film 67 is place on the XY-plane, the optical paths in the two measurement units 60a, 60b will be located on planes that are parallel with the XZ-plane.

By the use of the measurement device 80 disclosed in the aforesaid embodiment to apply the measurement method 50 of the present disclosure, a value relating to the angular mismatch in the double-sided optical film 67 can be measured.

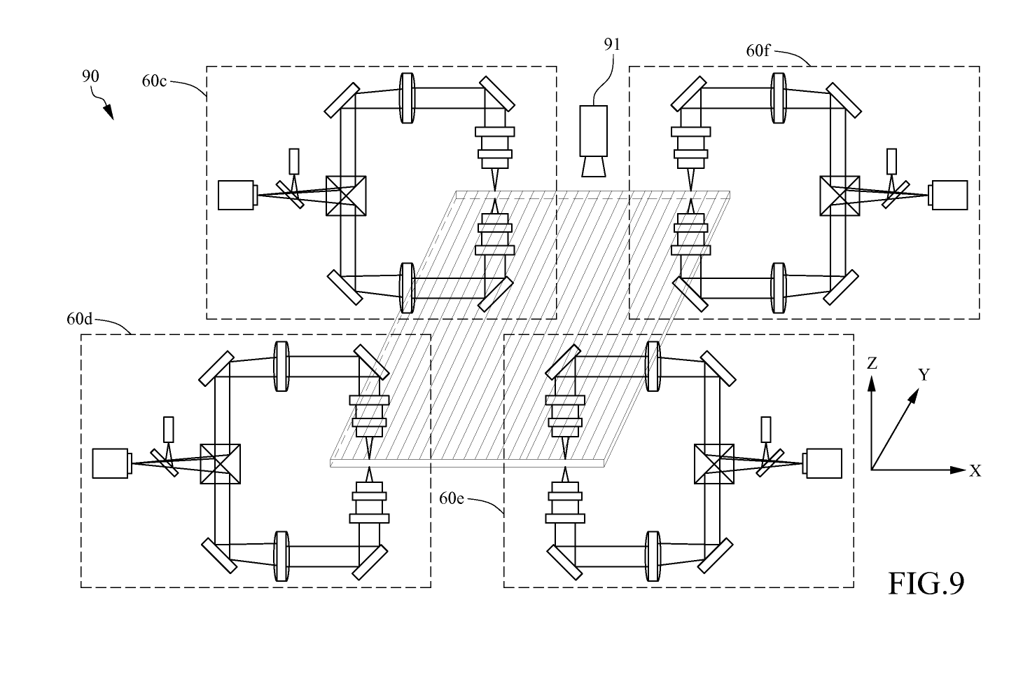

Since the aforesaid image analysis will be adversely affected by moiré pattern, it is required for the measurement device of the present disclosure to monitor whether there is a moiré pattern existed in the obtained images. Please refer to FIG. 9, which is a schematic diagram showing a measurement device of double-sided optical films according to yet another embodiment of the present disclosure. As shown in FIG. 9, a measurement device 90 adapted for measuring a double-sided optical film 67 characterized by a first profile and a corresponding second profile is disclosed, which includes:
four measurement units 60c, 60d, 60e, 60f, each for measuring horizontal mismatches relating to different locations on the double-sided optical film 67; and
an imaging component 91, for monitoring a detection range defined by the four measurement units 60c, 60d, 60e, 60f, with respect to whether there is a moire pattern formed therein;
   It is noted that any two neighboring measurement units in the four measurement units 60c, 60d, 60e, 60f are disposed spaced from each other by a specific distance, and each of the two measurement units 60c, 60d, 60e, 60f is configured the same as the measurement device 60 of FIG. 6 in view of function, structure and operation. Moreover, the imaging component 91 can be a CCD.

While defining by a Cartesian coordinate system of X, Y and Z axes, as shown in FIG. 9, if the double-sided optical film 67 is place on the XY-plane, the optical paths in the two measurement units 60c, 60d, 60e, 60f will be located on planes that are parallel with the XZ-plane.

By the use of the measurement device 90 disclosed in the aforesaid embodiment to apply the measurement method 50 of the present disclosure, a value relating to the horizontal mismatch in the double-sided optical film 67 can be measured.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A measurement method of double-sided optical films, comprising:
providing an double-sided optical film characterized by a first profile and a second profile;
generating a first image of the first profile and a corresponding second image of the second profile in a simultaneous manner;
enabling the first image and the second image to overlap with each other so as to form a superimposed image;
capturing the superimposed image; and
analyzing the superimposed image so as to obtain a value relating to the horizontal mismatch of the double-sided optical film.

2. The measurement method of claim 1, wherein in the step of the generating of the first image and the corresponding second image, the first profile and the second profile is illuminated by a mixed illumination of a dark-field illumination and a bright-field illumination.

3. A measurement method of double-sided optical films, comprising:
providing an double-sided optical film characterized by a first profile and a second profile whereas the double-sided optical film is made up of a plurality of parallel-arranged beam splitters;
capturing a first image and a second image relating to the first profile and simultaneously capturing a third image of the second profile corresponding to the first image of the first profile and also a fourth image of the second profile corresponding to the second image of the first profile while enabling the capturing processes of the first image and the second image are performed at different location spaced from each other by a specific distance;
enabling the first image and the third image to overlap with each other so as to form a first superimposed image while enabling the second image and the fourth image to overlap with each other so as to form a second superimposed image;
respectively capturing the first superimposed image and the second superimposed image; analyzing the first superimposed image so as to obtain a first horizontal mismatch value while analyzing the second superimposed image so as to obtain a second horizontal mismatch value; and
basing upon the first horizontal mismatch value and the second horizontal mismatch value to calculate a angular mismatch value of the double-sided optical film.

4. The measurement method of claim 3, wherein in the step of the generating of the first image, the second image, the third image and the fourth image, the first profile and the second profile is illuminated by a mixed illumination of a dark-field illumination and a bright-field illumination.

5. The measurement method of claim 3, wherein the calculation of the angular mismatch value further comprises the steps of:
subtracting the second horizontal mismatch value from the first second horizontal mismatch value so as to obtain a first measure;
dividing the first measure with the specific distance so as to obtain a second measure; and
calculating the arctangent of the second measure.

6. A measurement device adapted for measuring a double-sided optical film characterized by a first profile and a corresponding second profile, comprising:
a first image capturing unit, for generating a first image relating to the first profile;
a second image capturing unit, disposed at a position corresponding to the first image capturing unit for generating a second image of the second profile;
a superimposition unit, for enabling the first image and the second image to overlap with each other so as to form a superimposed image; and
an imaging unit, for capturing the superimposed image.

7. The measurement device of claim 6, wherein the imaging unit is a charge-coupled device (CCD).

8. The measurement device of claim 6, wherein the superimposition unit is a double-image prism.

9. The measurement device of claim 8, each of the first and the second image capturing unit is further comprised of:
an objective lens;
a first reflector, disposed at a position on the optical path between the objective lens and the double-image prism for reflecting light impinging thereon;
a second reflector, disposed at a position on the optical path between the objective lens and the first reflector for reflecting light impinging thereon; and
an imaging lens, disposed at a position on the optical path between the first reflector and the second reflector for focusing and imaging.

10. The measurement device of claim 9, further comprising:
a semi reflector, disposed at a position on the optical path between the double-image prism and the imaging unit while enabling the same to receive light from a light source for allowing a portion of the light to be reflected toward the double-image prism.

11. A measurement device adapted for measuring a double-sided optical film characterized by a first profile and a corresponding second profile, comprising:
a plurality of horizontal mismatch measurement units, being disposed spaced from one another by a specific distance so as to obtain various horizontal mismatch values of the double-sided optical film in correspondence to their different positions, each horizontal mismatch measurement unit further comprising:
a first image capturing unit, for generating a first image relating to the first profile;
a second image capturing unit, disposed at a position corresponding to the first image capturing unit for generating a second image of the second profile;
a superimposition unit, for enabling the first image and the second image to overlap with each other so as to form a superimposed image; and
an imaging unit, for capturing the superimposed image.

12. The measurement device of claim 11, wherein the imaging unit is a charge-coupled device (CCD).

13. The measurement device of claim 11, wherein the superimposition unit is a double-image prism.

14. The measurement device of claim 13, wherein each of the first and the second image capturing unit is further comprised of:
an objective lens;
a first reflector, disposed at a position on the optical path between the objective lens and the double-image prism for reflecting light impinging thereon;
a second reflector, disposed at a position on the optical path between the objective lens and the first reflector for reflecting light impinging thereon; and
an imaging lens, disposed at a position on the optical path between the first reflector and the second reflector for focusing and imaging.

15. The measurement device of claim 14, further comprising:
a semi reflector, disposed at a position on the optical path between the double-image prism and the imaging unit while enabling the same to receive light from a light source for allowing a portion of the light to be reflected toward the double-image prism.

16. The measurement device of claim 11, further comprising:
two measurement units, each for measuring horizontal mismatch.

17. The measurement device of claim 11, further comprising:
four measurement units, each for measuring horizontal mismatch; and
an imaging component, for monitoring a detection range defined by the four measurement units with respect to whether there is a moire pattern formed therein.

18. The measurement device of claim 17, wherein the imaging component is a charge-coupled device (CCD).
